(19) United States
(12) Patent Application Publication
(10) Pub. No.: US 2026/0066678 A1
(43) Pub. Date: Mar. 5, 2026

(54) VOLTAGE CLAMPING FOR MODULAR POWER SYSTEM

(71) Applicant: MILWAUKEE ELECTRIC TOOL CORPORATION, Brookfield, WI (US)

(72) Inventors: Gareth J. Mueckl, Milwaukee, WI (US); Matthew D. Post, Milwaukee, WI (US)

(21) Appl. No.: 19/308,696

(22) Filed: Aug. 25, 2025

Related U.S. Application Data
(60) Provisional application No. 63/687,415, filed on Aug. 27, 2024.

(51) Int. Cl. H02J 7/00; H01M 10/42; H01M 10/44

(52) U.S. Cl. CPC H02J 7/50; H01M 10/425; H01M 10/441; H02J 7/96; H01M 2010/4271

(57) ABSTRACT

A modular power system including a first modular battery core, a second modular battery core, and a controller electrically connected to the first modular battery core and the second modular battery core. The controller is configured to determine a first voltage of the first modular battery core and the second modular battery core and clamp the first modular battery core and the second modular battery core for a discharge operation when the first voltage is within a tolerance level of the second voltage.

### RELATED APPLICATIONS

This application claims the benefit of U.S. Provisional Patent Application No. 63/687,415, filed Aug. 27, 2024, the entire content of which is hereby incorporated by reference.

### SUMMARY

Modular systems can be used to efficiently store and transport equipment, for example, power tools, power supplies, accessories, and the like. Modular systems include, for example, battery cores, power supplies, chargers, rolling storage boxes, toolboxes, tool kits, organizers, power tool, accessories, and the like that interconnect with each other using modular mounting features. The modular mounting features include physical interfaces to physically interconnect two modular devices. These modular mounting features may be modified to also include electrical interfaces to electrically connect two modular electronic devices (e.g., power supplies, chargers, batteries, battery cores, and the like). Portable power supplies, chargers, batteries, and battery cores provide flexibility and convenience for providing power to electronic devices (e.g., power tools) at construction sites or event sites. Modular electronic devices can be constructed to be customizable and include any number of interchangeable modules for exchanging power and communications.

Two or more modular battery cores can be modularly connected together to form a modular power system. The modular power system can be reconfigured by removing or adding battery cores in between operations. Reconfiguring the modular power system may result in the battery cores of the modular power system having mismatched voltages. Accordingly, there is a need for clamping voltage in a modular power system. Clamping refers to concurrently using two or more battery cores for parallel discharge. Clamping battery cores for discharging in parallel provides maximum power output from a modular power system. Each battery core on a modular power system stack that has the same voltage (or state of charge) therefore could be discharged at the same time. Battery cores that are not the same voltage as the other cores on the modular power system stack can be charged, discharged, or balanced to reach the same voltage (or state of charge) before clamping. In these cases, it is advantageous to utilize voltage clamping of the battery cores to maximize a power output from the modular power system.

A modular power system described herein includes a first modular battery core, a second modular battery core, and a controller electrically connected to the first modular battery core and the second modular battery core. The controller is configured to determine a first voltage of the first modular battery core and the second modular battery core and clamp the first modular battery core and the second modular battery core for a discharge operation when the first voltage is within a tolerance level of the second voltage.

A method described herein includes determining, with a controller electrically connected to a first modular battery core and a second modular battery core, a first voltage of the first modular battery core and a second voltage of the second modular battery core, determining, with the controller, the first voltage is not within a tolerance level of the second voltage, discharging, with the controller, the first modular battery core to the second voltage, and clamping, with the controller, the first modular battery core and the second modular battery core for a discharge operation.

A modular power system described herein includes a first modular battery core, a second modular battery core, and a controller electrically connected to the first modular battery core and the second modular battery core. The controller is configured to determine a first voltage of the first modular battery core and a second voltage of the second modular battery core, and form a clamp unit by clamping the first modular battery core and the second modular battery core for a discharge operation when the first voltage is within a tolerance level of the second voltage.

Before any embodiments are explained in detail, it is to be understood that the embodiments are not limited in their application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 illustrates a modular power system, according to some embodiments.

FIGS. 2A and 2B illustrate modular electronic devices of the modular ecosystem, according to some embodiments.

FIG. 3 illustrates a block diagram of a modular battery core, according to some embodiments.

FIG. 4 illustrates a modular power system, according to some embodiments.

FIG. 5 is a block diagram of the modular power system of FIG. 4, according to some embodiments.

FIG. 6A illustrates a first example modular power system, according to some embodiments.

FIG. 6B is a first circuit schematic of the first example modular power system of FIG. 6A, according to some embodiments.

FIG. 7A illustrates a second example modular power system, according to some embodiments.

FIG. 7B is a second circuit schematic of the second example modular power system of FIG. 7A, according to some embodiments.

FIG. 8A illustrates a third example modular power system, according to some embodiments.

FIG. 8B is a third circuit schematic of the third example modular power system of FIG. 8A, according to some embodiments.

FIG. 9A illustrates a fourth example modular power system, according to some embodiments.

FIG. 9B is a fourth circuit schematic of the fourth example modular power system of FIG. 9A, according to some embodiments.

FIG. 10A illustrates a fifth example modular power system, according to some embodiments.

FIG. 10B is a fifth circuit schematic of the fifth example modular power system of FIG. 10A, according to some embodiments.

FIG. 11A illustrates a fifth example modular power system, according to some embodiments.

FIG. 11B is a fifth circuit schematic of the sixth example modular power system of FIG. 11A, according to some embodiments.

FIG. 12A illustrates a fifth example modular power system, according to some embodiments.

FIG. 12B is a fifth circuit schematic of the seventh example modular power system of FIG. 12A, according to some embodiments.

FIG. 13A illustrates an sixth example modular power system, according to some embodiments.

FIG. 13B is an sixth circuit schematic of the eighth example modular power system of FIG. 13A, according to some embodiments.

FIG. 14A illustrates a sixth example modular power system, according to some embodiments.

FIG. 14B is a sixth circuit schematic of the ninth example modular power system of FIG. 14A, according to some embodiments.

FIG. 15A illustrates a seventh example modular power system, according to some embodiments.

FIG. 15B is a seventh circuit schematic of the seventh example modular power system of FIG. 15A, according to some embodiments.

FIG. 16 illustrates a control diagram of modular battery core balancing for a modular power system, according to some embodiments.

FIG. 17 illustrates a flowchart of a method for clamping modular battery cores of a modular power system, according to some embodiments.

FIG. 18 illustrates a flowchart of a method for performing a discharge operation during a removal of a modular battery core from the modular power system, according to some embodiments.

FIG. 19 illustrates a flowchart of a method for charging a first modular battery core when a voltage of the first modular battery core is not within a tolerance level of a voltage of a second modular battery core, according to some embodiments.

FIG. 20 illustrates a flowchart of a method for discharging a first modular battery core to a voltage of a second modular battery core in order to clamp the first modular battery core and the second modular battery core, according to some embodiments.

FIG. 21 illustrates a flowchart of a method for balancing voltages of a first modular battery core and a second modular battery core, according to some embodiments.

FIG. 22 is a first example use of the modular power system of FIG. 1, according to some embodiments.

FIG. 23 is a second example use of the modular power system of FIG. 1, according to some embodiments.

FIG. 24 is a third example use of the modular power system of FIG. 1, according to some embodiments.

### DETAILED DESCRIPTION

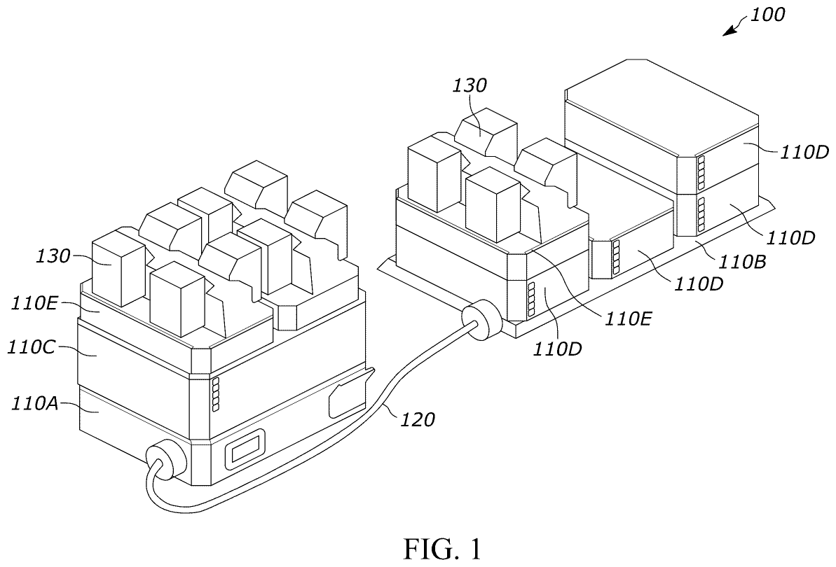

FIG. 1 illustrates an example modular ecosystem 100. The modular ecosystem 100 includes a plurality of modular electronic devices 110 electrically and physically coupled together, for example, using modular mounting features and/or wires 120. The modular ecosystem 100 allows for both power transfer and communication between the various modular electronic devices 110. The communication may be performed using a controller area network (CAN) bus protocol. The modular electronic devices 110 include, for example, a portable power supply 110A, a floor plate 110B, a full width battery core 110C (e.g., a power core of battery cells), a plurality of half width battery cores 110D (e.g., a small core of battery cells), a plurality of charging modules 110E for charging battery packs 130. In one example, the wire 120 may include a cord that allows for power and communication between the connected modular electronic devices 110. The wire 120 provides an alternate connection scheme (e.g., daisy-chain) to connect the modular electronic devices 110.

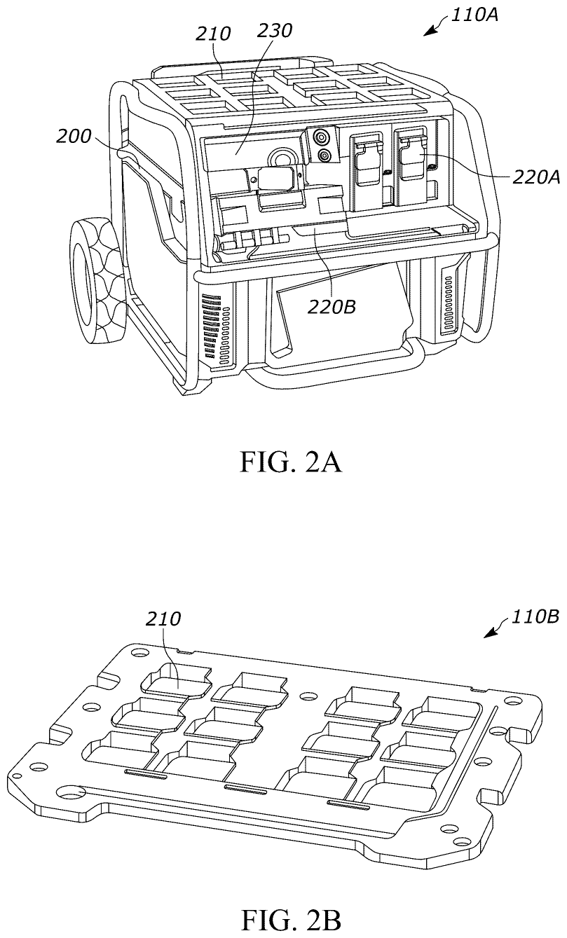

FIG. 2A illustrates an example embodiment of a modular electronic device 110, for example, a portable power supply 110A. The portable power supply 110A includes, among other things, a housing 200 made of, for example, impact resistant polymer plastic material. The housing 200 may be made using an injection molding process, a 3-D printing process, or the like. The housing 200 includes modular mounting features 210 provided on a top surface of the housing 200. Corresponding interlocking modular mounting features may be provided on bottom surface of the housing 200 that interlock with the modular mounting features 210 on the top of another modular electronic device 110. The portable power supply 110A further includes a power output unit 220 and a display 230. A power input unit may also be provided including multiple electrical connection interfaces configured to receive power from an external power source. The external power source may be a DC power source or an AC power source. For example, the AC power source may be a conventional wall outlet, such as a 120 V outlet or a 240 V outlet, found in North America.

The power output unit 220 includes one more power outlets. In the illustrated embodiment, the power output unit 220 includes a plurality of AC power outlets 220A and DC power outlets 220B. It should be understood that number of power outlets included in the power output unit 220 is not limited to the power outlets illustrated in FIG. 2A. For example, the power output unit 220 may include more or fewer power outlets than the power outlets included in the illustrated embodiment of portable power supply 110A.

The power output unit 220 may be configured to provide power output from an internal power source to one or more peripheral devices. For example, the power output unit 220 may be configured to provide power provided by an external power source directly to one or more peripheral devices. The one or more peripheral devices may be a smartphone, a tablet computer, a laptop computer, a portable music player, a power tool, a power tool battery pack (e.g., a battery pack 130 [see FIG. 1]), a power tool battery pack charger, or the like. The peripheral devices may be configured to receive DC and/or AC power from the power output unit 220.

The display 230 is configured to indicate a state of the portable power supply 110A to a user, such as state of charge of the internal power source 240 and/or fault conditions. In some embodiments the display 230 includes one or more light-emitting diode (“LED”) indicators configured to illuminate and display a current state of charge of internal power source 240. In some embodiments, the display 230 is, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, an electronic ink display, etc. In other embodiments, the portable power supply 110A does not include a display.

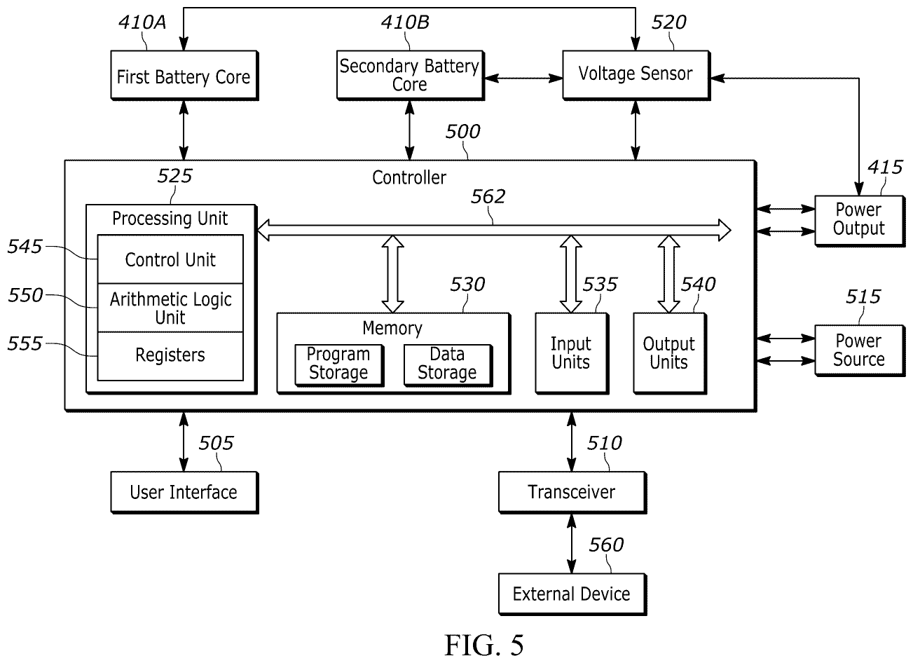

FIG. 2B illustrates an example embodiment of a modular electronic device 110, for example, a floor plate 110B. The floor plate 110B may be made of metal or other durable material stamped in the form of a plate and to include the modular mounting features 210. The portable power supply 110A represents an active modular electronic device 110 including a controller 500 (see FIG. 5). The floor plate 110B may be a passive modular electronic device 110 that may not include a controller.

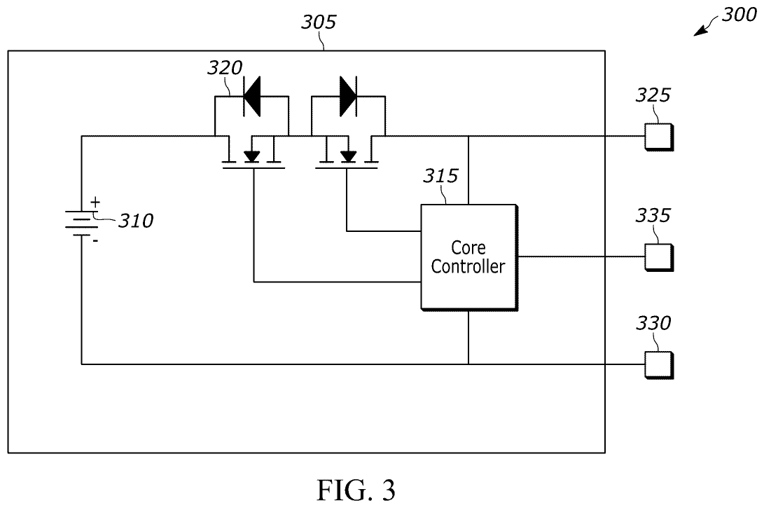

FIG. 3 illustrates a block diagram 300 of a modular battery core 305. The modular battery core 305 (“battery core”) may be any one of the modular electronic devices 110. Each of the modular battery cores 305 includes a separate housing and can be used independently of other modular battery cores 305 to power a device or to be charged. For example, the battery core may be a full width battery core 110C or a half width battery core 110D. The battery core 305 includes a plurality of internal battery cells 310, a core controller 315, and a switching circuit 320. The battery core 305 includes a positive power terminal 325, a negative power terminal 330, and one or more communication terminals 335 (referred to as terminals 325-335). The battery core 305 is electrically connected to a power source (e.g., the portable power supply 110A, an AC power source, etc.) a power output, or the like using the terminals 325-335. The terminals 325-335 may be provided with the modular mounting features 210 such that an automatic parallel connection and a power bus may be formed when two or more battery cores 305 are stacked together.

The internal battery cells 310 may include lithium-ion battery cells or battery cells of a different chemistry, for example, nickel-cadmium, nickel-metal hydride, and the like. The battery core 305 may be rated at 3 kilowatt-hours (KWh).

The switching circuit 320 may control when the internal battery cells 310 are connected/disconnected to at least one of the power source and the power output. For example, the switching circuit 320 may including a discharging switch that is enabled to discharge the internal battery cells 310 and a charging switch that is enabled to charge the internal battery cells 310. The switching circuit 320 may include switches, relays, and the like. For example, the switching circuit may include at least one field effect transistor (FET), such as a metal oxide semiconductor FET (MOSFET), a wide bandgap semiconductor FET, a bipolar junction transistor (BJT), a relay, or the like. The core controller 315 may control the switching circuit 320 to prevent power from flowing into/out of the internal battery cells 310 when not intended. For example, if a first battery core 305 is being charged but a second battery core 305 connected on a stack to the first battery core 305 does not need to be charged (e.g., the first battery core 305 has a lower voltage than the second battery core 305), the core controller 315 of the second battery core 305 may control the switching circuit 320 to disconnect the internal battery cells 310 from the power bus.

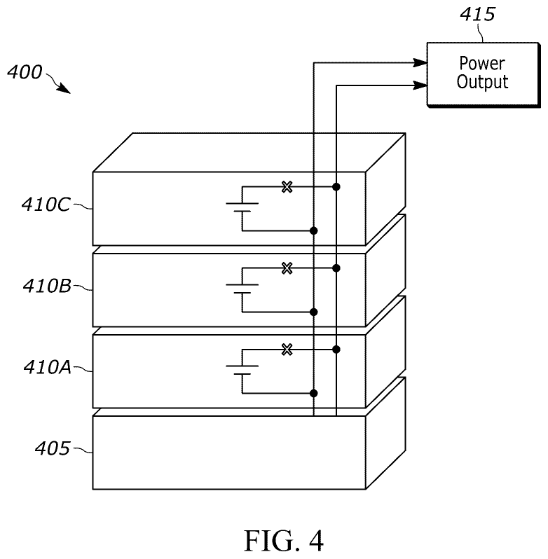

FIG. 4 illustrates a modular power system 400. The modular power system 400 includes a power supply module 405 (“power supply”), a first battery core 410A, a second battery core 410B, and a third battery core 410C. The battery cores 410 may be the same as the battery core 305 (FIG. 3). The power supply 405 may be considered a power source (e.g., power supply 110A) or may be connected to a power source (e.g., an AC wall outlet). In the example embodiment, first battery core 410A, the second battery core 410B, and the third battery core 410C are vertically stacked on top of one another and on top of the power supply 405, however, they may be provided in other configurations. For example, a first interface of the first battery core 410A may be connected to an interface of the power supply 405 and a second interface of the first battery core 410A may be connected to a third interface of the second battery core 410B. A fourth interface of the second battery core 410B may be connected to a fifth interface of the third battery core 410C. As discussed above, each of the interfaces may be provided in the modular mounting features.

Power may be provided from the modular power system 400 to a power output 415 during a discharge operation. For example, voltages of the first battery core 410A, the second battery core 410B, and the third battery core 410C may be equal such that the modular power system 400 is a clamped modular power system that discharges each battery core 410 in parallel. When each battery core 410 is rated at 3 kWh, the power output 415 receives 9 kWh.

FIG. 5 is a schematic illustration of a controller 500 of a modular device of a modular power system 400, for example, any of the modular electronic devices 110A, 110C, 110D, 110E, the power supply module 405, and the battery cores 410. The controller 500 is electrically and/or communicatively connected to a variety of modules or components of the modular power system 400. For example, the illustrated controller 500 is connected to a user interface 505, a transceiver 510, a power source 515, a power output 415, a voltage sensor 520, a first battery core 410A, and a second battery core 410B. The electrical connection between the controller 500 and the battery cores 410 illustrates the communicative connection between the various components of the modular power system 400. That is, the controller 500 may be provided in any of the devices of the modular power system 400 and communicates with other controllers 500 of other devices of the modular power system 400 using, for example, a controller area network (CAN) protocol. The power source 515 may include, for example, the power supply 405, an AC power source (e.g., wall outlet), removable battery packs, battery cores 410 (e.g., non-removable) including stacks of series and/or parallel connected battery cells, and the like. The power output 415 may include the AC/DC outputs, charging interfaces to charge the battery packs 130, a power tool connected to the clamped modular power system 400, and the like.

The controller 500 includes combinations of hardware and software that are operable to, among other things, control the operation of the modular power system 400. For example, the controller 500 includes, among other things, a processing unit 525 (e.g., a microprocessor, a microcontroller, an electronic processor, an electronic controller, or another suitable programmable device), a memory 530, input units 535, and output units 540. The processing unit 525 includes, among other things, a control unit 545, an arithmetic logic unit (“ALU”) 550, and a plurality of registers 555 (shown as a group of registers in FIG. 5) and is implemented using a known computer architecture (e.g., a modified Harvard architecture, a von Neumann architecture, etc.). The processing unit 525, the memory 530, the input units 535, and the output units 540, as well as the various modules or circuits connected to the controller 500 are connected by one or more control and/or data buses (e.g., common bus 562). The control and/or data buses are shown generally in FIG. 5 for illustrative purposes. Although the controller 500 is illustrated in FIG. 5 as one controller, the controller 500 could also include multiple controllers configured to work together to achieve a desired level of control for the modular power system 400. As such, any control functions and processes described herein with respect to the controller 500 could also be performed by two or more controllers functioning in a distributed manner.

The memory 530 is a non-transitory computer readable medium and includes, for example, a program storage area and a data storage area. The program storage area and the data storage area can include combinations of different types of memory, such as a read only memory (“ROM”), a random access memory (“RAM”) (e.g., dynamic RAM [“DRAM”], synchronous DRAM [“SDRAM”], etc.), electrically-erasable programmable ROM (“EEPROM”), flash memory, a hard disk, an SD card, or other suitable magnetic, optical, physical, or electronic memory devices. The processing unit 525 is connected to the memory 530 and is configured to execute software instructions that are capable of being stored in a RAM of the memory 530 (e.g., during execution), a ROM of the memory 530 (e.g., on a generally permanent basis), or another non-transitory computer readable medium such as another memory or a disc. Software included in the implementation of the modular power system 400 and controller 500 can be stored in the memory 530 of the controller 500. The software includes, for example, firmware, one or more applications, program data, filters, rules, one or more program modules, and other executable instructions. The controller 500 is configured to retrieve from the memory 530 and execute, among other things, instructions related to the control processes and methods described herein. In other embodiments, the controller 500 includes additional, fewer, or different components.

The controller 500 determines voltage levels of at least the first battery core 410A and the second battery core 410B and clamps the first battery core 410A and the second battery core 410B together when their voltages are within a tolerance level of one another to form a clamped modular power system. For example, the voltage sensor 420 senses a first voltage of the first battery core 410A and a second voltage of the second battery core 410B and communicates the first voltage and the second voltage to the controller 500. When the first voltage is substantially equal to the second voltage (e.g., within a tolerance rang), the controller 500 clamps the first battery core 410A and the second battery core 410B together.

The controller 500 may only perform a clamping operation on the first battery core 410A and the second battery core 410B when a clamping operation mode is selected by a user. For example, a user may use the user interface 505 or an external device 560 to select the clamping operation mode. The user interface 505 may include a button, a touchscreen, and the like that receives input from a user.

The transceiver 510 may send and receive data from the modular power system 400 to other devices. For example, the transceiver 510 may allow the controller 500 to communicate with other devices (e.g., the external device 560) over a network or via a wired connection. The external device 560 may include an application that allows the user to select the clamping operation mode.

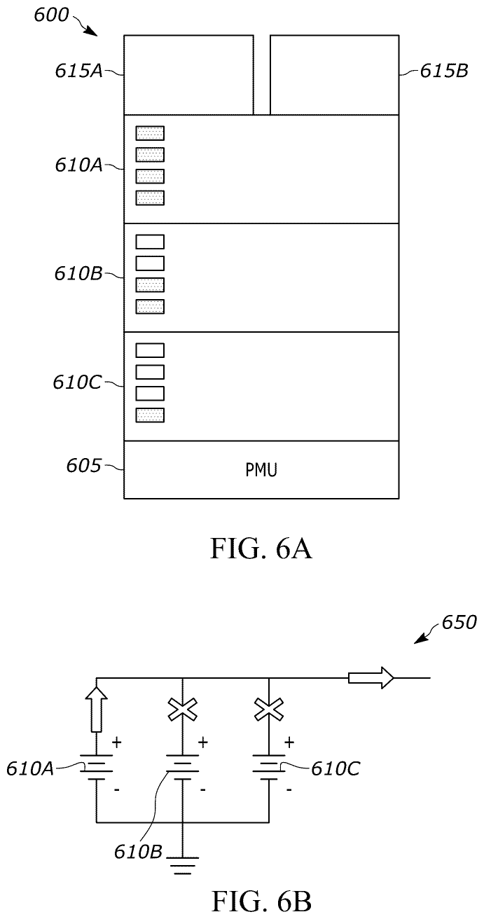

FIG. 6A illustrates a first example modular power system 600. The first example modular power system 600 may include a power management unit 605 (e.g., power supply), a first battery core 610A, a second battery core 610B, a third battery core 610C, a first charger module 615A, and a second charger module 615B. The first battery core 610A, the second battery core 610B, and the third battery core 610C may be the same as the modular battery core 305 (FIG. 3). The power supply 605 may be the same as power supply 405 (FIG. 4). The first battery core 610A, the second battery core 610B, and the third battery core 610C are vertically stacked on top of the power supply unit 605 to form a stack. The first charger module 615A and the second charger module 615B may be provided on a top side of the third battery core 610C.

The first battery core 610A is at a first voltage, the second battery core 610B is at a second voltage that is greater than the first voltage, and the third battery core 610C is at a third voltage that is greater than the second voltage. The voltage of a battery core 610 refers to the combined stack voltage of the internal battery cells 310 of the battery core 610 between the most positive battery cell 310 and the most negative battery cell 310 of the battery core 610. The controller 500 may be provided in the power supply 605 and may determine the voltages of the battery cores 610, for example, with the voltage sensor 520. In some examples, each battery core 610 may have a separate voltage sensor 520 and the controller 500 determines the voltages of the battery cores 610 based on a communication with the respective controllers of the battery cores 610. The battery cores 610 of the first example modular power system 600 are not clamped because the voltages of the battery cores 610 are mismatched.

FIG. 6B is a first circuit schematic 650 of the first example modular power system 600. The third battery core 610C is discharging in the first circuit schematic 650. The power output flowing from the first example modular power system 600 may be coming from the third battery core 610C. For example, the power output may be equal to a power output from the third battery core 610C. The first battery core 610A and the second battery core 610B are not discharging in the first circuit schematic 650. The controller 500 may discharge the third battery core 610C to one of the first voltage and the second voltage. The controller 500 may enable the third battery core 610C and disable the first battery core 610A and the second battery core 610B using the respective switching circuits 320 of the battery cores 610.

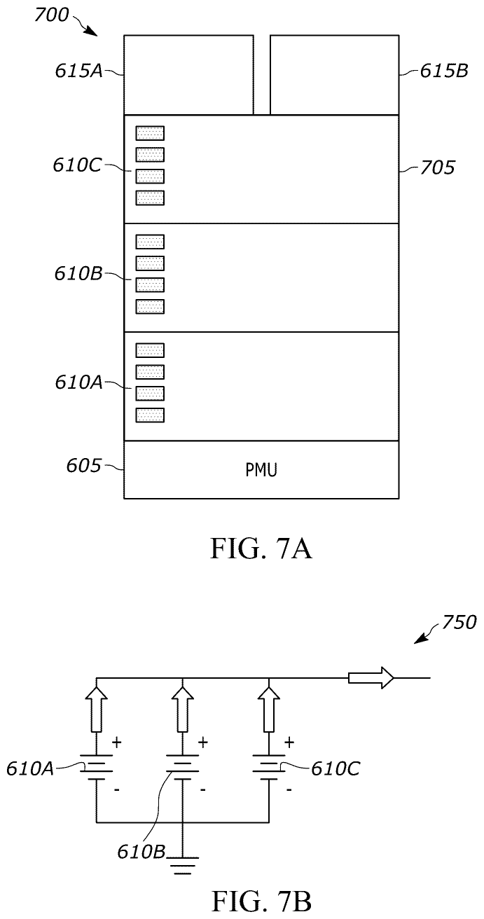

FIG. 7A illustrates a second example modular power system 700. The second example modular power system 700 may include the power supply 605, the first battery core 610A, the second battery core 610B, the third battery core 610C, the first charger module 615A, and the second charger module 615B. The first battery core 610A, the second battery core 610B, and the third battery core 610C are clamped together to form a clamped unit 705. The first battery core 610A, the second battery core 610B, and the third battery core 610C are vertically stacked on top of the power supply unit 605 to form a stack. The first charger module 615A and the second charger module 615B may be provided on a top side of the third battery core 610C such that the first charger module 615A and the second charger module 615B are physically connected to only the third battery core 610C.

The first battery core 610A, the second battery core 610B, and the third battery core 610C are at the same voltage (that is, a first voltage). Alternatively, the first battery core 610A, the second battery core 610B, and the third battery core 610C may be within a tolerance level of one another. For example, the tolerance level may be ±1V such that each battery core 610 has a voltage that is within ±1V of the other voltages. The controller 500 may be provided in the power supply 605 and may determine the voltages of the battery cores 610, for example, with the voltage sensor 520. The battery cores 610 of the first example modular power system 600 are clamped, forming the clamped unit 705. For example, the controller 500 may determine that the first battery core 610A, the second battery core 610B, and the third battery core 610C are at a first voltage and are clamped together for a discharge operation.

FIG. 7B is a second circuit schematic 750 of the second example modular power system 700. The first battery core 610A, the second battery core 610B and, the third battery core 610C are discharging in the second circuit schematic 750. The power output flowing from the second example modular power system 700 may be coming from all of the battery cores 610. For example, the power output may be equal to a sum of the power output from the battery cores 610 (e.g., 9 kWh when each battery core 610 provides 3 kWh). The controller 500 may discharge each battery core 610 at a same rate to maintain equal voltage levels throughout the clamped discharge process.

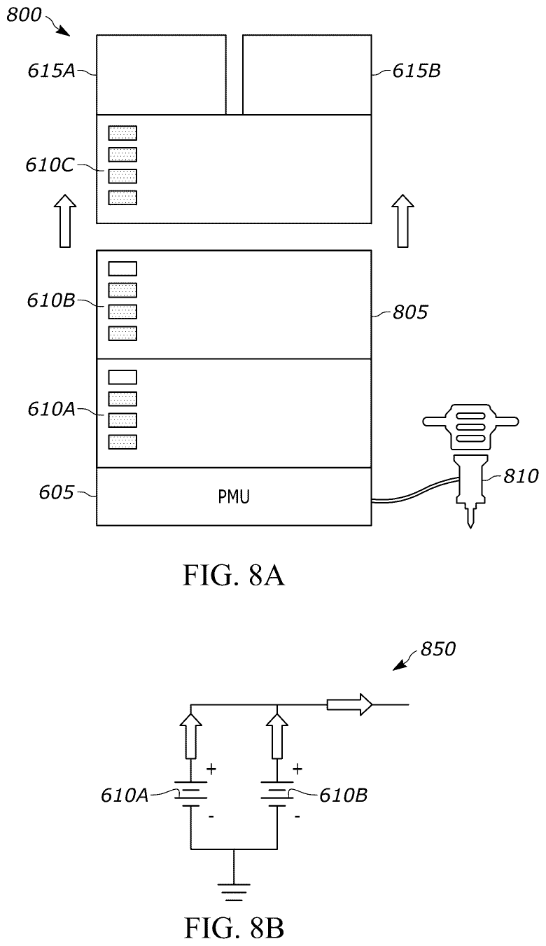

FIG. 8A illustrates a third example modular power system 800. The third example modular power system 800 may include the power supply 605, the first battery core 610A, the second battery core 610B, the third battery core 610C, the first charger module 615A, and the second charger module 615B. The first battery core 610A and the second battery core 610B are clamped together to form a clamped unit 805. The first battery core 610A and the second battery core 610B are vertically stacked on top of the power supply unit 605 to form a stack. A power tool 810 is connected to the power supply 605 and may be receiving power from the clamped unit 805. The third battery core 610C may be removed from the clamped unit 805 while the clamped unit 805 is discharging to the power tool 810. For example, the third battery core 610C may be physically detached from the second battery core 610B while the clamped unit 805 is performing a discharge operation. The first charger module 615A and the second charger module 615B may be provided on a top side of the third battery core 610C.

The first battery core 610A and the second battery core 610B are at a first voltage. Alternatively, the voltages of the first battery core 610A and the second battery core 610B are within a tolerance level of one another. For example, the tolerance level may be ±1V such that the first battery core 610A and the second battery core 610B have a voltage that is within ±1V of the other voltages. The third battery core 610C may be a second voltage that is different that the first voltage. For example, the second voltage may be greater than the first voltage. The controller 500 may be provided in the power supply 605 and may determine the voltages of the battery cores 610, for example, with the voltage sensor 520.

FIG. 8B is a third circuit schematic 850 of the third example modular power system 800. The first battery core 610A and the second battery core 610B are discharging in the third circuit schematic 850. The power output flowing from the third example modular power system 800 may be coming from the first battery core 610A and the second battery core 610B. For example, the power output may be equal to a sum of the power output from the first battery core 610A and the second battery core 610B (e.g., 6 kWh when the first battery core 610A and the second battery core 610B each provide 3 kWh). The controller 500 may discharge the first battery core 610A and the second battery core 610B at a same rate to maintain equal voltage levels throughout the clamped discharge process. The third battery core 610C may be removed during operation without affecting operation of the clamped unit 805 since the third battery core 610C is not part of the clamped unit 805.

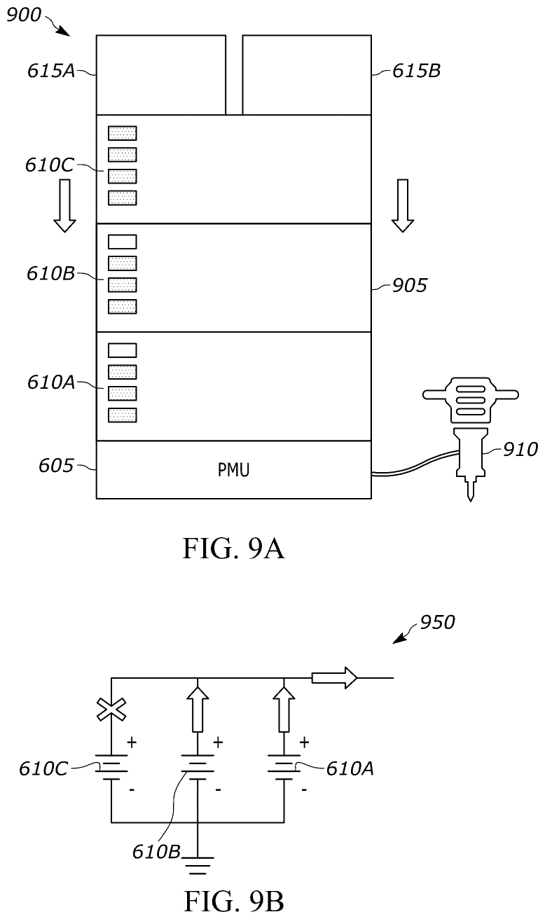

FIG. 9A illustrates a fourth example modular power system 900. The fourth example modular power system 900 may include the power supply 605, the first battery core 610A, the second battery core 610B, the third battery core 610C, the first charger module 615A, and the second charger module 615B. The first battery core 610A and the second battery core 610B are clamped together to form a clamped unit 905. The first battery core 610A and the second battery core 610B are vertically stacked on top of the power supply unit 605 to form a stack. A power tool 910 is connected to the power supply 605 and may be receiving power from the clamped unit 905. The third battery core 610C may be added to the clamped unit 905 while the clamped unit 905 is discharging to the power tool 910 to become a part of the stack. For example, the third battery core 610C may be physically attached to the second battery core 610B while the clamped unit 805 is performing a discharge operation. The first charger module 615A and the second charger module 615B may be provided on a top side of the third battery core 610C.

The first battery core 610A and the second battery core 610B are at a first voltage. Alternatively, the voltages of the first battery core 610A and the second battery core 610B are within a tolerance level of one another. For example, the tolerance level may be ±1V such that the first battery core 610A and the second battery core 610B have a voltage that is within ±1V of the other voltages. The third battery core 610C may be a second voltage that is different that the first voltage. For example, the second voltage may be greater than the first voltage. The controller 500 may be provided in the power supply 605 and may determine the voltages of the battery cores 610, for example, with the voltage sensor 520. The third battery core 610C may be added during operation without affecting operation of the clamped unit 905 since the third battery core 610C is not part of the clamped unit 905.

FIG. 9B is a fourth circuit schematic 950 of the fourth example modular power system 900. The first battery core 610A and the second battery core 610B are discharging in the fourth circuit schematic 950. The power output flowing from the fourth example modular power system 900 may be coming from the first battery core 610A and the second battery core 610B. For example, the power output may be equal to a sum of the power output from the first battery core 610A and the second battery core 610B (e.g., 6 kWh when the first battery core 610A and the second battery core 610B each provide 3 kWh). The controller 500 may discharge the first battery core 610A and the second battery core 610B at a same rate to maintain equal voltage levels throughout the clamped discharge process. Though attached to the clamped unit 905, the third battery core 610C is not discharging.

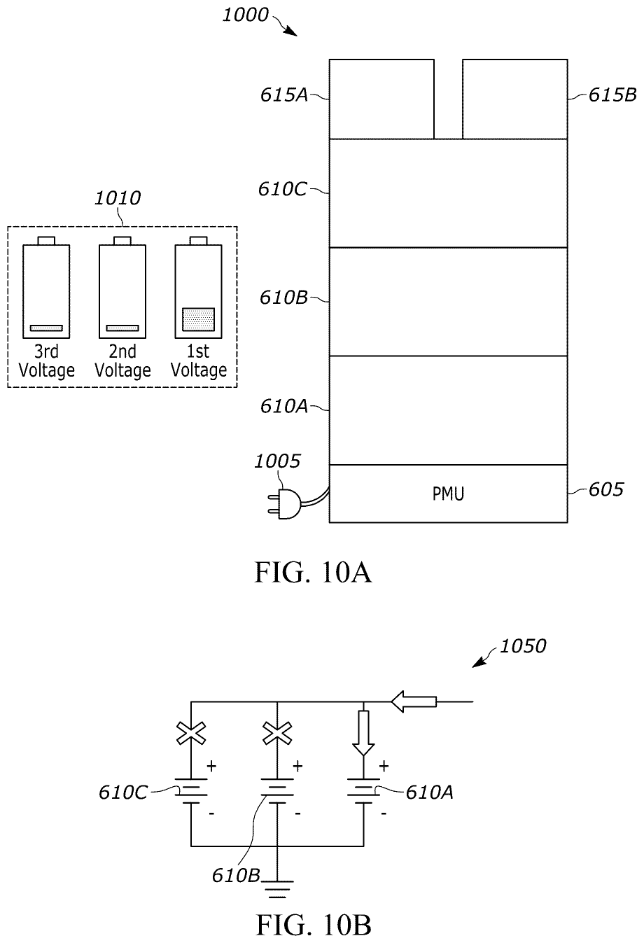

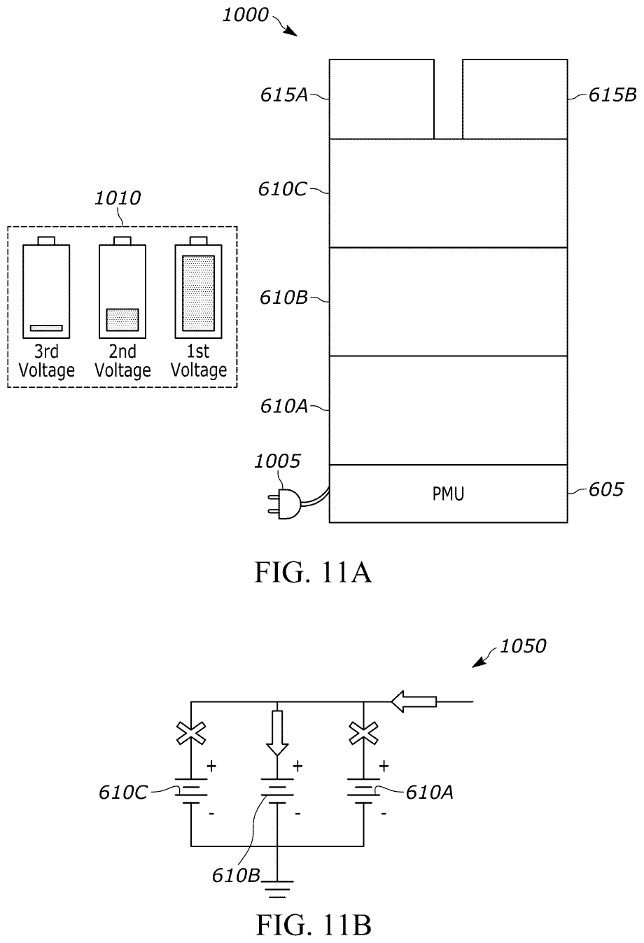

The modular power systems described herein may be charged overnight, for example, when not in use for powering devices. The charging may be performed sequentially such that each battery core 610 is charged separately and independent of the other battery cores in a sequential order. FIGS. 10A-12B illustrate an example sequential charging operation of the modular power systems.

FIG. 10A illustrates a fifth example modular power system 1000. The fifth example modular power system 1000 may include the power supply 605, the first battery core 610A, the second battery core 610B, the third battery core 610C, the first charger module 615A, and the second charger module 615B. The first battery core 610A, the second battery core 610B, and the third battery core 610C are vertically stacked on top of the power supply unit 605 to form a stack. A power input cord 1005 (e.g., a power cord that plugs into a wall outlet) is connected to the power supply 605 and may be providing power to at least one of the battery cores 610. The first charger module 615A and the second charger module 615B may be provided on a top side of the third battery core 610C. The first battery core 610A may be selected to be charged first during sequential charging.

FIG. 10B is a fifth circuit schematic 1050 of the fifth example modular power system 1000. The first battery core 610A is charging in the fifth circuit schematic 1050. The first battery core 610A may be charged to the full charge voltage before one of the second battery core 610B or the third battery core 610C receives a charging current via the power input cord 1005. Switching circuits, such as switching circuit 320 (FIG. 3), within each battery cores 610 may connect the first battery core 610A to a voltage bus that is provided within each battery core 610 in the fifth example modular power system 1000 that is providing the charging current and may disconnect the second battery core 610B and the third battery core 610C from the voltage bus. The voltage bus may facilitate the transfer of power to and from each battery core 610. For example, power may be provided from the first battery core 610A to an output device (e.g., a charging module) coupled to one of the first battery core 610A, the second battery core 610B, and the third battery core 610C.

FIGS. 11A-11B illustrates the fifth example modular power system 1000 during a sequential charging operation when the first battery core 610A is fully charged and the second battery core 610B is being charged.

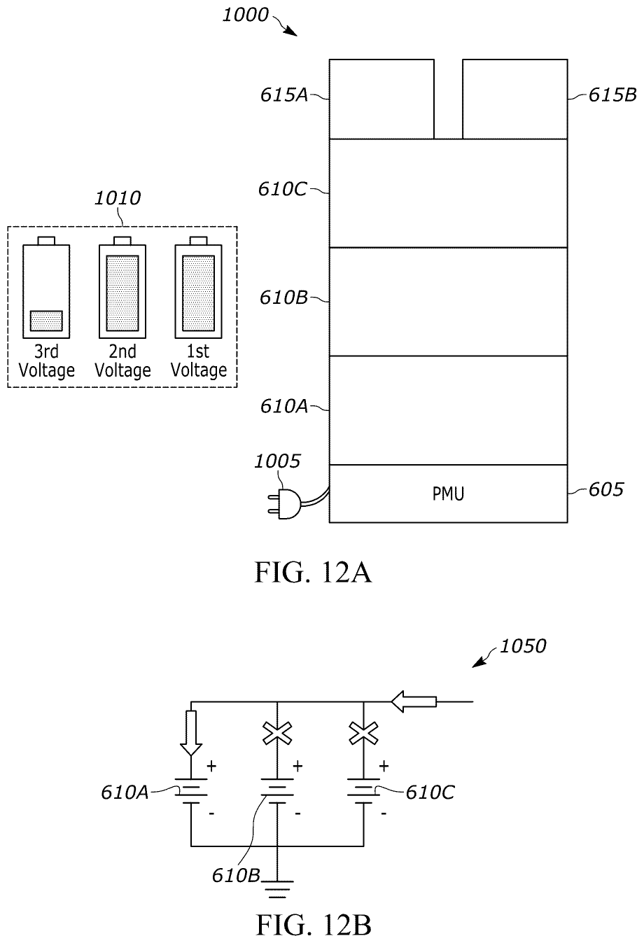

FIGS. 12A-12B illustrates the fifth example modular power system 1000 during a sequential charging operation when the first battery core 610A and the second battery core 610B are fully charged and the third battery core 610C is being charged

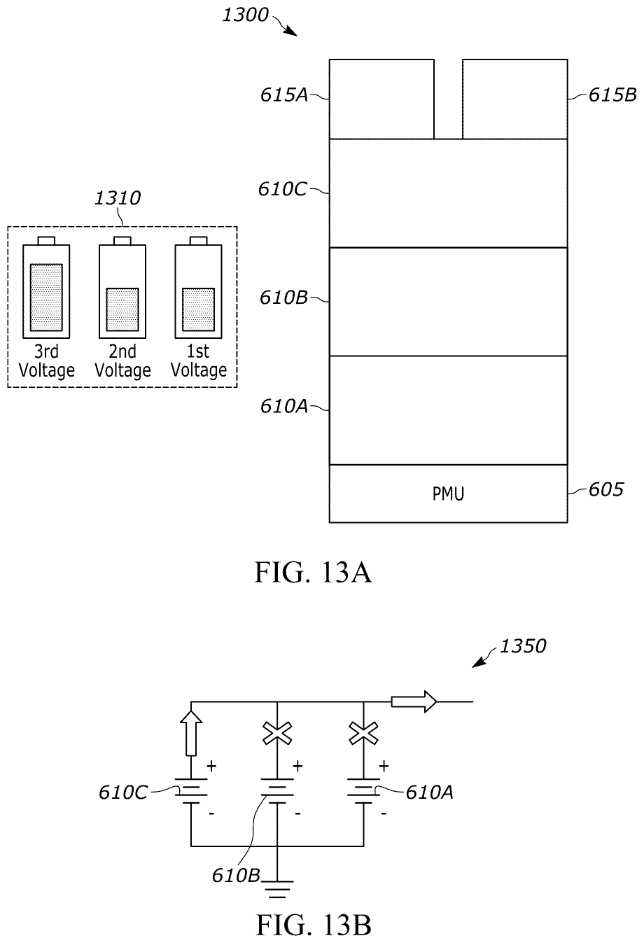

When a clamping mode is not selected, the modular power systems described herein may discharge the battery cores 610 sequentially. In some examples, when the clamping mode is selected and the battery cores 610 are at different voltages, the modular power systems described herein may control operations to equalize the voltages before clamping the battery cores 610. FIGS. 13A-16 illustrate examples of different example equalization methods when clamping mode is selected.

FIG. 13A illustrates a sixth example modular power system 1300. The sixth example modular power system 1300 may include the power supply 605, the first battery core 610A, the second battery core 610B, the third battery core 610C, the first charger module 615A, and the second charger module 615B. The first battery core 610A, the second battery core 610B, and the third battery core 610C are vertically stacked on top of the power supply unit 605 to form a stack. The first charger module 615A and the second charger module 615B may be provided on a top side of the third battery core 610C. The first battery core 610A and the second battery core 610B may be clamped together to form a clamp unit 1305.

The charge levels 1310 of the battery cores 610 are shown in FIG. 13A. The first battery core 610A is at a first voltage, the second battery core 610B is at the first voltage, and the third battery core 610C is at a second voltage. The first voltage may be between a no charge voltage and a full charge voltage. The second voltage may be a full charge voltage. The controller 500 may be provided in the power supply 605 and may determine the voltages of the battery cores 610, for example, with the voltage sensor 520.

FIG. 13B is a sixth circuit schematic 1350 of the sixth example modular power system 1300. The third battery core 610C is discharging in the sixth circuit schematic 1350. The third battery core 610C may be discharged to the first voltage such that the third battery core 610C is at a same voltage as the first battery core 610A and the second battery core 610B. Switching circuits, such as switching circuit 320 (FIG. 3), within each battery cores 610 may connect the third battery core 610C to a voltage bus in the sixth example modular power system 1300 to discharge and may disconnect the first battery core 610A and the second battery core 610B from the voltage bus. The third battery core 610C may be discharging to a load. The controller 500 may periodically pause the discharge of the third battery core 610C to determine an instant voltage of the third battery core 610C.

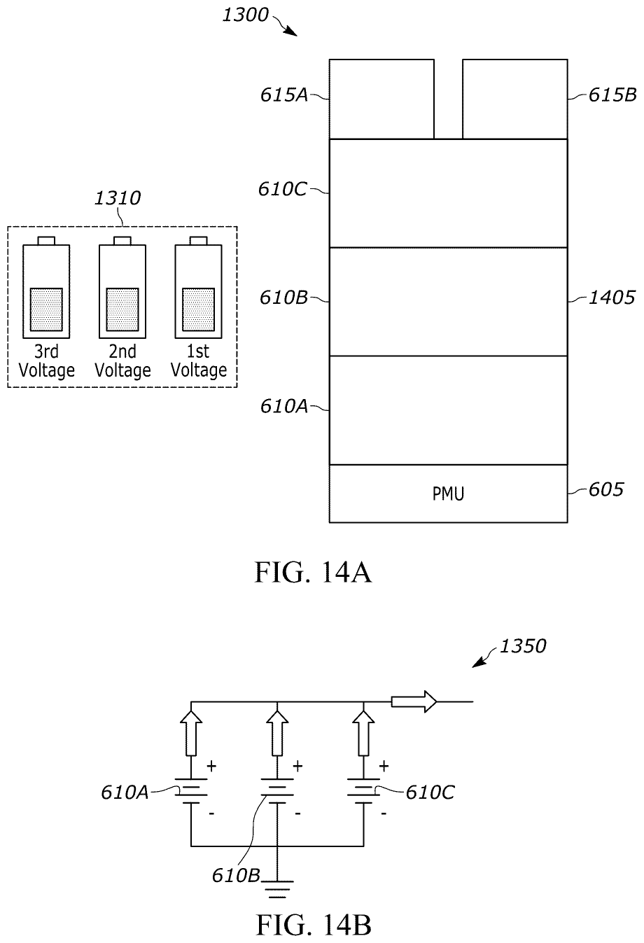

FIGS. 14A-14B illustrates illustrate the sixth example modular power system 1300 when the third battery core 610C is discharged to the first voltage. The first battery core 610A, the second battery core 610B and, the third battery core 610C are clamped together for discharging. The power output flowing from the sixth example modular power system 1300 is provided from all of the battery cores 610. For example, the power output may be equal to a sum of the power output from the battery cores 610 (e.g., 9 kWh when each battery core 610 provides 3 kWh). The controller 500 may discharge each battery core 610 at a same rate to maintain equal voltage levels throughout the clamped discharge process.

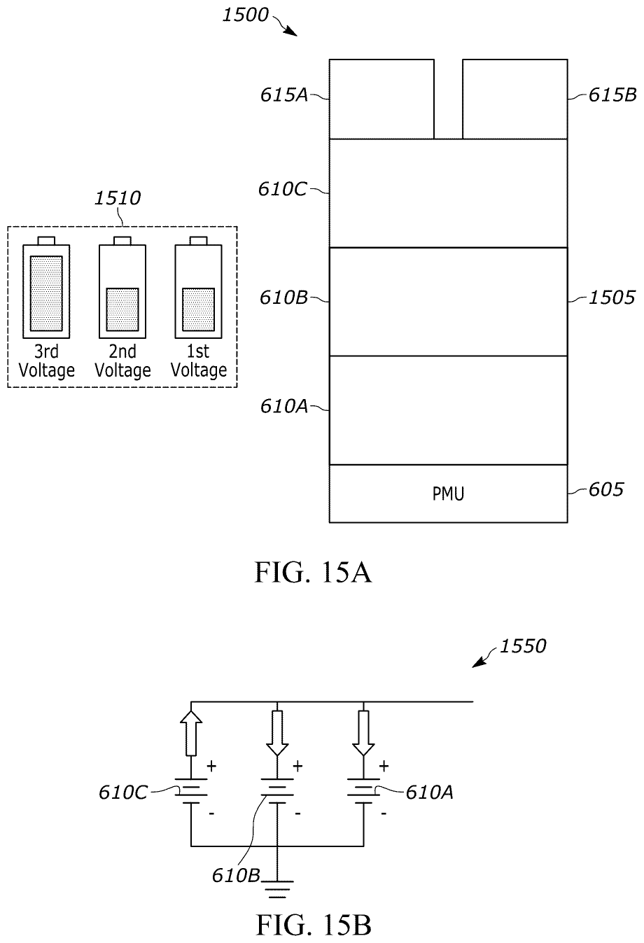

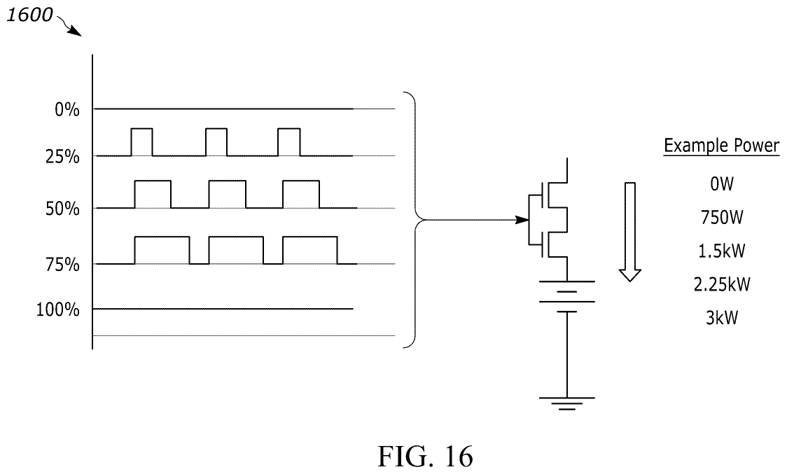

FIG. 15A illustrates a seventh example modular power system 1500. The seventh example modular power system 1500 may include the power supply 605, the first battery core 610A, the second battery core 610B, the third battery core 610C, the first charger module 615A, and the second charger module 615B. The first battery core 610A, the second battery core 610B, and the third battery core 610C are vertically stacked on top of the power supply unit 605 to form a stack. The first charger module 615A and the second charger module 615B may be provided on a top side of the third battery core 610C. The first battery core 610A and the second battery core 610B may be clamped together to form a clamp unit 1505. The seventh example modular power system 1400 may be an example power system during battery core equalization. For example, the third battery core 610C may be discharged and the first battery core 610A and the second battery core 610B may be charged with the power being discharged from the third battery core 610C in the seventh example modular power system 1500. In other words, the battery cores 610 may be performing battery core balancing in order for each battery core 610 to be the same voltage, as will be described below with respect to FIG. 16.

The charge levels 1510 of the battery cores 610 are shown in FIG. 15A. The first battery core 610A is at a first voltage, the second battery core 610B is at the first voltage, and the third battery core 610C is at a second voltage. The first voltage may be between a no charge voltage and a full charge voltage. The second voltage may be a full charge voltage. The controller 500 may be provided in the power supply 605 and may determine the voltages of the battery cores 610, for example, with the voltage sensor 520.

FIG. 15B is a seventh circuit schematic 1550 of the seventh example modular power system 1500. The first battery core 610A and the second battery core 610B are receiving a charging current and the third battery core 610C is discharging in the seventh circuit schematic 1550. For example, the third battery core 610C may be providing 3 kWh and the first battery core 610A and the second battery core 610B may each receive 1.5 kWh.

FIG. 16 illustrates a control diagram 1600 of modular battery core balancing for a modular power system. The controller 500 may implement the control diagram 1600 to perform battery core balancing. The controller 500 may pulse a switch circuit 320 of a battery core 610 using a pulse width modulation (PWM) signal to limit the amount of current flowing into the battery core 610. With reference to FIG. 15A, the controller 500 may control the switch circuit 320 of the first battery core 610A and the second battery core 610B using a PWM signal with one of a 25%, 50%, or 75% duty ratio. Based on the duty ratio, the first battery core 610A and the second battery core 610B may be charged over a first amount of time using current from the third battery core 610C. In one example, the 25% duty ratio may provide 750 watts (W) of power to the first battery core 610A and the second battery core 610B, the 50% duty ratio may provide 1.5 kilowatts (KW) of power to the first battery core 610A and the second battery core 610B, and the 75% duty ratio may provide 2.25 kW of power to the first battery core 610A and the second battery core 610B. The first battery core 610A and the second battery core 610B may be charged to a full charge voltage and are not overcharged due to the controller 500 controlling the switch circuit 320 in the battery cores 610A, 610B. For example, the switch circuit 320 is controlled to only be on for a portion of time, thus, limiting the current flow to the batteries of the battery cores 610.

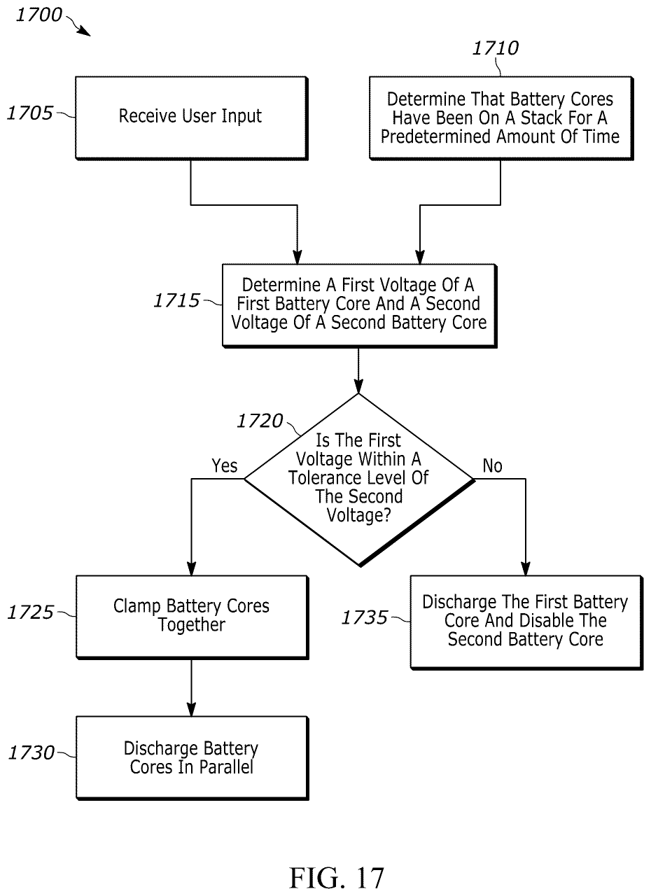

FIG. 17 illustrates a flowchart of a method 1700 for clamping modular battery cores 610 of a modular power system (e.g., first-seventh example modular power systems 600-1500). Although the illustrated method 1700 includes specific steps, not all of the steps need to be performed or need to be performed in the order presented. The method 1700 may be executed by the controller (e.g., the controller 500 of the power supply 605).

The method 1700 includes receiving a user input (step 1705). The user input may be provided through a user interface (e.g., user interface 505) or received from an external device (e.g., external device 560) via a transceiver (e.g., 510). The user input may be a clamping operation mode input. For example, the clamping operation mode input may enable the controller 500 to clamp battery cores together for a discharge operation.

The method 1700 includes determining that battery cores 610 have been on a stack for a predetermined amount of time (step 1710). For example, the controller 500 may determine that at least a first battery core 610A and a second battery core 610B have been coupled to a power supply 605 (e.g., forming a stack) for the predetermined amount of time. The predetermined amount of time may be at least 60 minutes. The controller 500 clamps the battery cores 610 when the user input selecting a clamping mode is received or when the battery core 610 are connected for the predetermined amount of time. In some examples, the setting to clamp when the battery cores 610 are connected for the predetermined amount of time or the predetermined amount of time are configurable.

The method 1700 includes determining a first voltage of a first battery core 610A and a second voltage of a second battery core 610B (step 1715). The controller 500 may use a voltage sensor (e.g., voltage sensor 520) to determine the first voltage and the second voltage. A first battery core controller (e.g., core controller 315) of the first battery core 610A and a second battery core controller of the second battery core 610B may communicate a voltage of an internal battery (e.g., internal battery cells 310) of the first battery core 610A and the second battery core 610B to the controller 500.

The method 1700 includes determining whether the first voltage is within a tolerance level of the second voltage (decision step 1720). For example, the tolerance level may be ±1V such that the first voltage is within ±1V of the second voltage. The tolerance level may be any voltage in the range of 0V to 5V. The controller 500 may determine a difference between the first voltage and the second voltage and compare the difference to the tolerance level. When the first voltage is within a tolerance level of the second voltage (YES at decision step 1720), the method 1700 proceeds to step 1725. When the first voltage is not within a tolerance level of the second voltage (NO at decision step 1720), the method 1700 proceeds to step 1735.

The method 1700 includes clamping the battery cores 610 together (step 1725). When clamped together, the first battery core 610A and the second battery core 610B form a clamp unit (e.g., clamp unit 705 [FIGS. 7A-7B]) and engage in the clamping operation mode. The battery cores 610 may be clamped together using the respective switching circuits 320. For example, the controller 500 of each of the battery cores 610 may enable or disable the corresponding switching circuit 320 based on determining whether the battery cores 610 are to be clamped together.

The method 1700 includes discharging the battery cores 610 in parallel (step 1730). The controller 500 controls the first battery core 610A and the second battery core 610B to both discharge at the same time. For example, the first battery core 610A may provide a 3 kWh output and the second battery core 610B may also provide a 3 kWh output such that the clamp unit 705 provides a 6 kWh output to a load connected to the modular power system. To discharge the battery cores 610, the controller 500 may control a switching circuit (e.g., switching circuit 320 [FIG. 3]) in each battery core to be in an ON position.

The method 1700 includes discharging the first battery core 610A and disabling the second battery core 610B (step 1735). For example, when the first voltage of the first battery core 610A is not within a tolerance level of the second voltage of the second battery core 610B, the battery cores 610 cannot discharge in parallel and, instead, discharge in series. Discharging exclusively the first battery core 610A provides an output equal to the output of the first battery core 610A. For example, when the first battery core 610A provides a 3 kWh output, the 3 kWh output is provided to a load connected to the modular power system. The second battery core 610B does not discharge.

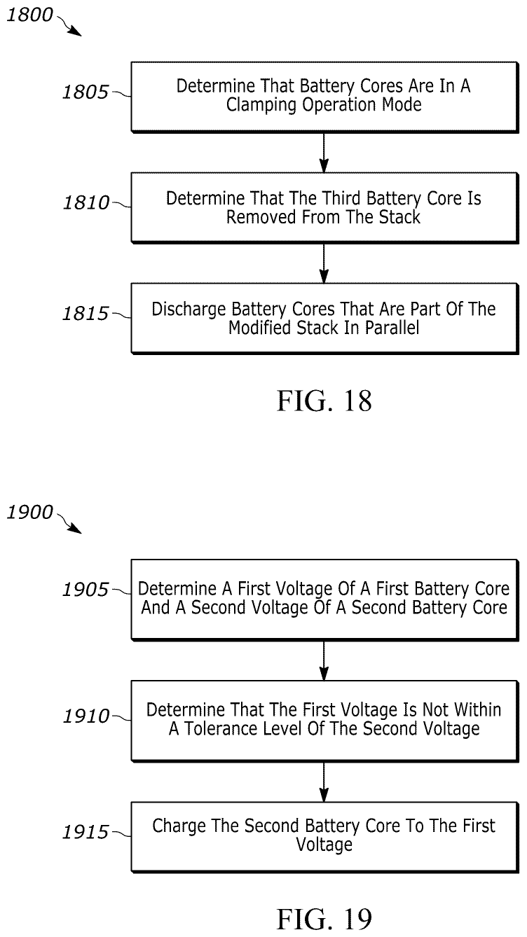

FIG. 18 illustrates a flowchart of a method 1800 for performing a discharge operation during a removal of a modular battery core 610 from the modular power system (e.g., first-seventh example modular power systems 600-1500). Although the illustrated method 1800 includes specific steps, not all of the steps need to be performed or need to be performed in the order presented. The method 1800 may be executed by the controller (e.g., the controller 500 of the power supply 605).

The method 1800 includes determining that battery cores 610 are in a clamping operation mode (step 1805). For example, the controller 500 may perform steps of method 1700 to clamp a first battery core 610A, a second battery core 610B, and a third battery core 610C. The controller 500 may determine that the first battery core 610A, the second battery core 610B, and the third battery core 610C are in a clamping operation mode based on the output from the clamp unit 705. For example, the controller 500 may determine that the output is a sum of an output of the first battery core 610A, an output of the second battery core 610B, and an output of the third battery core 610C to determine that the first battery core 610A, the second battery core 610B, and the third battery core 610C are clamped together.

The method 1800 includes determining that the third battery core 610C is removed from the stack (step 1810). For example, the controller 500 may determine that the first battery core 610A and a second battery core 610B remain coupled to a power supply 605 (e.g., forming the stack) and that the third battery core 610C is physically and electrically disconnected from the stack. A user may remove the third battery core 610C from the stack such that the modified stack includes the battery cores 610A, 610B.

The method 1800 includes discharging battery cores 610A, 610B that are part of the modified stack in parallel (step 1815). The first battery core 610A and the second battery core 610B remain clamped in the clamping operation mode even though a previously clamped battery core (i.e., third battery core 610C) is removed from the clamp unit. The controller 500 discharges the first battery core 610A and the second battery core 610B in parallel to a load coupled to the modular power system.

FIG. 19 illustrates a flowchart of a method 1900 for charging a first modular battery core 610Awhen a voltage of the first modular battery core 610A is not within a tolerance level of a voltage of a second modular battery core 610B. Although the illustrated method 1900 includes specific steps, not all of the steps need to be performed or need to be performed in the order presented. The method 1900 may be executed by the controller (e.g., the controller 500 of the power supply 605).

The method 1900 includes determining a first voltage of a first battery core 610A and a second voltage of a second battery core 610B (step 1905). The controller 500 may use a voltage sensor (e.g., voltage sensor 520) to determine the first voltage and the second voltage. A first battery core controller (e.g., core controller 315) of the first battery core 610A and a second battery core controller of the second battery core 610B may communicate a voltage of an internal battery (e.g., internal battery cells 310) of the first battery core 610A and the second battery core 610B to the controller 500.

The method 1900 includes determining that the first voltage is not within a tolerance level of the second voltage (step 1910). For example, the tolerance level may be ±1V such that the first voltage is within ±1V of the second voltage. The tolerance level may be any voltage in the range of 0V to 5V. The controller 500 may determine a difference between the first voltage and the second voltage and compare the difference to the tolerance level. The first voltage may be a full charge voltage. The second voltage may be between a no charge voltage and a full charge voltage.

The method 1900 includes charging the second battery core 610B to the first voltage (step 1915). For example, the second battery core 610B may be charged to the first voltage via a power input cord 1005. A switching circuit (e.g., switching circuit 320 [FIG. 3]) may connect the second battery core 610B to a voltage bus that is providing the charging current and may disconnect the first battery core 610A from the voltage bus. The second battery core 610B is charged to the first voltage so the voltage of the first battery core 610A and the voltage of the second battery core 610B are equal and the battery core 610 can be clamped.

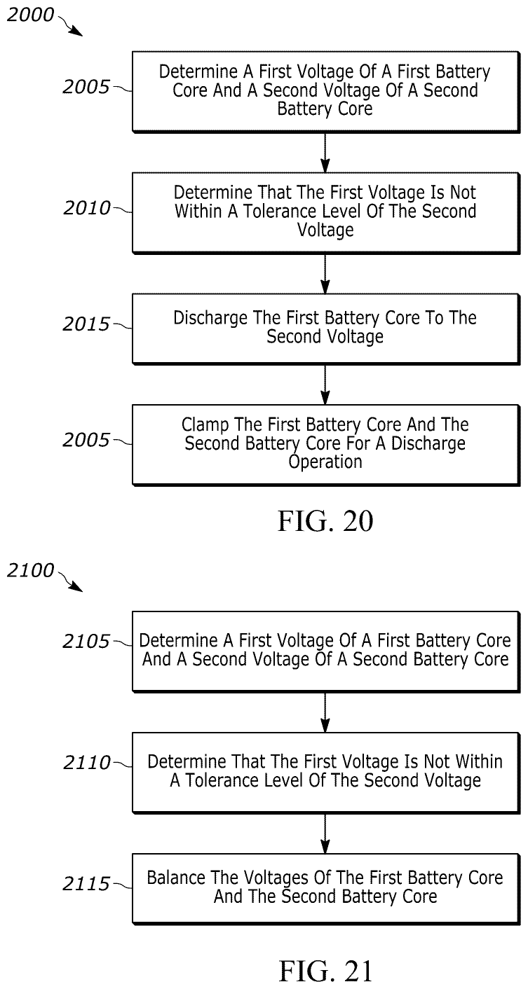

FIG. 20 illustrates a flowchart of a method 2000 for discharging a first modular battery core 610A to a voltage of a second modular battery core 610B in order to clamp the first modular battery core 610A and the second modular battery core 610B. Although the illustrated method 2000 includes specific steps, not all of the steps need to be performed or need to be performed in the order presented. The method 2000 may be executed by the controller (e.g., the controller 500 of the power supply 605).

The method 2000 includes determining a first voltage of a first battery core 610A and a second voltage of a second battery core 610B (step 2005). The controller 500 may use a voltage sensor (e.g., voltage sensor 520) to determine the first voltage and the second voltage. A first battery core controller (e.g., core controller 315) of the first battery core 610A and a second battery core controller of the second battery core 610B may communicate a voltage of an internal battery (e.g., internal battery cells 310) of the first battery core 610A and the second battery core 610B to the controller 500.

The method 2000 includes determining that the first voltage is not within a tolerance level of the second voltage (step 2010). For example, the tolerance level may be ±1V such that the first voltage is within ±1V of the second voltage. The tolerance level may be any voltage in the range of 0V to 5V. The controller 500 may determine a difference between the first voltage and the second voltage and compare the difference to the tolerance level. The first voltage may be a full charge voltage. The second voltage may be between a no charge voltage and a full charge voltage.

The method 2000 includes discharging the first battery core 610A to the second voltage (step 2015). A switching circuit (e.g., switching circuit 320 [FIG. 3]) may connect the first battery core 610A to a voltage bus to discharge current to a load and may disconnect the second battery core 610B from the voltage bus.

The method 2000 includes clamping the first battery core 610A and the second battery core 610B for a discharge operation (step 2020). When clamped together, the first battery core 610A and the second battery core 610B form a clamp unit (e.g., clamp unit 705 [FIGS. 7A-7B]) and engage in the clamping operation mode. The controller 500 may control the first battery core 610A and the second battery core 610B to both discharge at the same time. For example, the first battery core 610A may provide a 3 kWh output and the second battery core 610B may also provide a 3 kWh output such that the clamp unit 705 provides a 6 kWh output to a load connected to the modular power system. To discharge the battery cores 610, the controller 500 may control a switching circuit 320 in each battery core to be in an ON position.

FIG. 21 illustrates a flowchart of a method 2100 for balancing voltages of a first modular battery core 610A and a second modular battery core 610B. Although the illustrated method 2100 includes specific steps, not all of the steps need to be performed or need to be performed in the order presented. The method 2100 may be executed by the controller (e.g., the controller 500 of the power supply 605).

The method 2100 includes determining a first voltage of a first battery core 610A and a second voltage of a second battery core 610B (step 2105). The controller 500 may use a voltage sensor (e.g., voltage sensor 520) to determine the first voltage and the second voltage. A first battery core controller (e.g., core controller 315) of the first battery core 610A and a second battery core controller of the second battery core 610B may communicate a voltage of an internal battery (e.g., internal battery cells 310) of the first battery core 610A and the second battery core 610B to the controller 500.

The method 2100 includes determining that the first voltage is not within a tolerance level of the second voltage (step 2110). For example, the tolerance level may be ±1V such that the first voltage is within ±1V of the second voltage. The tolerance level may be any voltage in the range of 0V to 5V. The controller 500 may determine a difference between the first voltage and the second voltage and compare the difference to the tolerance level. The first voltage may be a full charge voltage. The second voltage may be between a no charge voltage and a full charge voltage.

The method 2100 includes balancing the voltages of the first battery core 610A and the second battery core 610B (step 2115). The controller 500 may balance the voltages by providing the second battery core 610B with a charging current from the first battery core 610A. For example, the first battery core 610A may provide 3 kWh to the second battery core 610B for the voltages of the first battery core 610A and the second battery core 610B to reach a third voltage. The controller 500 may control the switch circuit 320 of the second battery core 610B using a PWM signal with one of a 25%, 50%, or 75% duty ratio. Based on the duty ratio, the second battery core 610B may be charged over a first amount of time using current from the first battery core 610A.

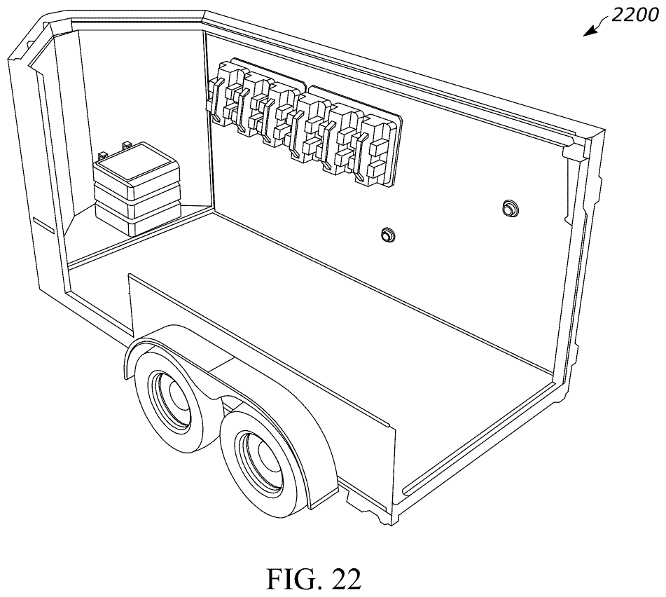

FIG. 22 illustrates an example charging system 2200 for the modular power system (e.g., first-seventh example modular power systems 600-1500). The charging system 2200 may be provided in a vehicle that may be used for charging the battery cores 610 overnight. The clamp unit 705 may provide an output to a load (e.g., charger modules 615). Each battery core 610 may be rated at 20 ampere-hours (Ah) may be able to be charged in 30-45 minutes. As discussed above, the battery cores 610 are charged sequentially in some examples.

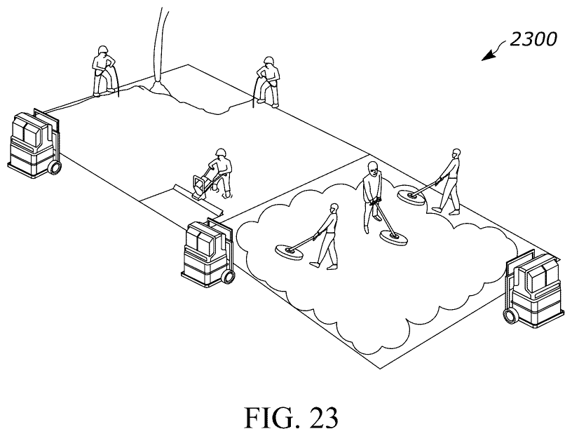

FIG. 23 is a first example use 2300 of the modular power system (e.g., first-seventh example modular power systems 600-1500). The first example use 2300 may include multiple second example modular power systems 700 on a concrete worksite. A user may enable the clamping operation mode of the modular power systems 700 to discharge enough battery cores 610 over a period of time to ensure that concrete work tools may be properly battery powered during a time-sensitive concrete pour.

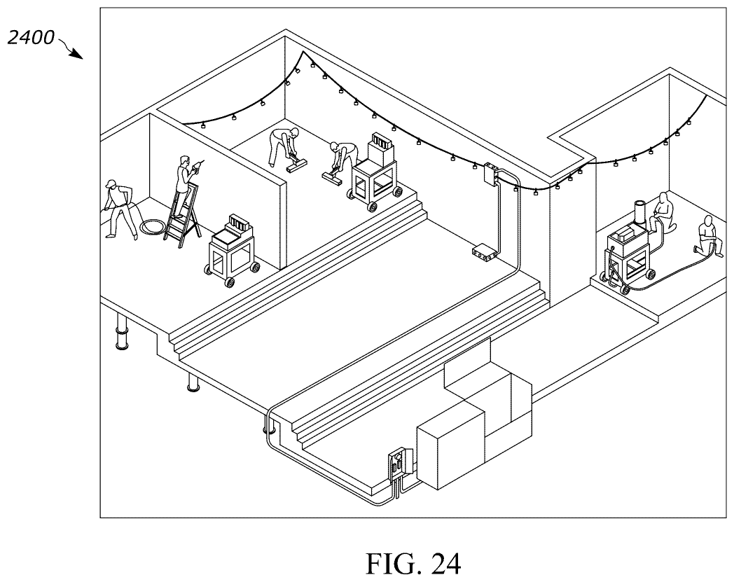

FIG. 24 is a second example use 2400 of the modular power system (e.g., first-seventh example modular power systems 600-1500). The second example use 2400 may include multiple second example modular power systems 700 on a construction worksite. Users may be able to draw power from the second example modular power systems 700 to perform construction tasks. The second example modular power systems 700 may be kept in the clamping operation mode.

In the above examples, clamping is described with respect to voltages and/or states of charges of the battery cores 610. The battery cores 610 may include the same rated nominal voltage such that the voltage (e.g., open circuit voltage or closed circuit voltage) are the same at a particular state of charge. However, the voltage at a state of charge may vary based on the relative age of the battery cores 610. In the examples, where battery cores 610 with different ages are used, the system may use the voltage measurements rather than the state of charge to determine whether to clamp.

Thus, embodiments described herein provide, among other things, systems and methods for clamping modular battery cores of a modular power system for a discharge operation.

What is claimed is:

1. A modular power system comprising:
a first modular battery core;
a second modular battery core; and
a controller electrically connected to the first modular battery core and the second modular battery core, the controller configured to:
determine a first voltage of the first modular battery core and a second voltage of the second modular battery core, and
clamp the first modular battery core and the second modular battery core for a discharge operation when the first voltage is within a tolerance level of the second voltage.

2. The modular power system of claim 1, wherein the controller is further configured to:
in response to determining that the first voltage is greater than the second voltage by over the tolerance level:
discharge the first modular battery core, and
disable the second modular battery core.

3. The modular power system of claim 2, wherein a voltage bus is provided within the first modular battery core and the second modular battery core, and wherein a discharge current is provided from the first modular battery core to an output module through the voltage bus when the second modular battery core is disabled.

4. The modular power system of claim 1, wherein the controller is further configured to charge the second modular battery core to the first voltage when the first voltage is greater than the second voltage by over the tolerance level.

5. The modular power system of claim 1, wherein the controller is further configured to balance voltages of the first modular battery core and the second modular battery core when the first voltage is greater than the second voltage by over the tolerance level.

6. The modular power system of claim 5, wherein the controller is configured to balance voltages of the first modular battery core and the second modular battery core by:
controlling a switching circuit of one of the first modular battery core and the second modular battery core using a PWM signal having a duty ratio less than 100%, and
providing, via the switching circuit, a charging current to the one of the first modular battery core and the second modular battery core.

7. The modular power system of claim 1, wherein the first modular battery core includes a first interface, wherein the second modular battery core includes a second interface, and wherein the first modular battery core is removable coupled to the second modular battery core via the first interface and the second interface.

8. The modular power system of claim 1, wherein the controller is further configured to:
discharge the first modular battery core and the second modular battery core in parallel in response to clamping the first modular battery core and the second modular battery core.

9. The modular power system of claim 8, wherein the controller discharges the first modular battery core and the second modular battery core in parallel by controlling a first discharging switch in the first modular battery core and a second discharging switch in the second modular battery core.

10. The modular power system of claim 1, further comprising:
a power supply including a first interface connected to a second interface of the first modular battery core.

11. The modular power system of claim 10, wherein a third interface of the first modular battery core is connected to a fourth interface of the second modular battery core.

12. A method comprising:
determining, with a controller electrically connected to a first modular battery core and a second modular battery core, a first voltage of the first modular battery core and a second voltage of the second modular battery core,
determining, with the controller, the first voltage is not within a tolerance level of the second voltage,
discharging, with the controller, the first modular battery core to the second voltage, and
clamping, with the controller, the first modular battery core and the second modular battery core for a discharge operation.

13. The method of claim 12, further comprising:
providing, with the controller, the second modular battery core with a charging current from the first modular battery core.

14. The method of claim 13, wherein the controller controls a switch circuit within the second modular battery core using a PWM signal to provide the second modular battery core with the charging current.

15. The method of claim 12, wherein the first modular battery core includes a first interface and a second interface, wherein the second modular battery core includes a third interface and a fourth interface, and wherein the second interface is connected to the third interface.

16. A modular power system comprising:
a first modular battery core;
a second modular battery core; and
a controller electrically connected the first modular battery core and the second modular battery core, the controller configured to:
determine a first voltage of the first modular battery core and a second voltage of the second modular battery core, and
form a clamp unit by clamping the first modular battery core and the second modular battery core for a discharge operation when the first voltage is within a tolerance level of the second voltage.

17. The modular power system of claim 16, wherein the first modular battery core includes a first interface and a second interface, wherein the second modular battery core includes a third interface and a fourth interface, and wherein the second interface is connected to the third interface.

18. The modular power system of claim 17, further comprising:
a third modular battery core including a fifth interface and a sixth interface and connected to the second modular battery core at the fourth interface with the fifth interface; and
an output device connected to the sixth interface.

19. The modular power system of claim 18, wherein the controller is configured to discharge the clamp unit to the output device connected to the third modular battery core.

20. The modular power system of claim 18, wherein the output device is a charging module for charging a plurality of battery packs.

21. The modular power system of claim 16 further including a power management system electrically connected to the first modular battery core and the second modular battery core.

22. The modular power system of claim 16, wherein a voltage bus is provided within the first modular battery core and the second modular battery core, and wherein a discharge current is provided from the first modular battery core and the second modular battery core to an output module through the voltage bus when one of the first modular battery core and the second modular battery core are disabled.
